(19) United States
(12) Patent Application Publication
(10) Pub. No.: US 2026/0054858 A1
(43) Pub. Date: Feb. 26, 2026

(54) REUSABLE SPACE VEHICLE FOR LONG-DWELL PAYLOAD HOSTING, ORBITAL MANEUVERS, AND DOWNMASS OPERATIONS, AND RELATED METHOD

(71) Applicant: STOKE Space Technologies, Inc., Kent, WA (US)

(72) Inventors: David R. Buckley Biggs, Seattle, WA (US); Thomas Ryan McCullough, Seatle, WA (US); Patrick Ryan Ball, Seattle, WA (US); Justin Kayvon Bahrami, Bellevue, WA (US); Devon Andreas Papandrew, Edmonds, WA (US)

(21) Appl. No.: 19/152,854

(22) PCT Filed: Mar. 4, 2025
(86) PCT No.: PCT/US2025/018300

§ 371 Date: Jul. 31, 2025

Related U.S. Application Data
(60) Provisional application No. 63/561,260, filed on Mar. 4, 2024.

(51) Int. Cl. B64G 1/14; B64G 1/40; B64G 1/58; F02K 9/46; F02K 9/50

(52) U.S. Cl. CPC B64G 1/14; B64G 1/402; F02K 9/46; F02K 9/50; B64G 1/58

(57) ABSTRACT

A vehicle configured for in-space and atmospheric reentry operations includes a pressure-fed propulsion engine that uses cryogenic fuel and cryogenic oxidizer as propellants. In some embodiments, the vehicle includes a first conduit configured to provide a first propellant to the pressure-fed propulsion engine, a second conduit configured to provide a second propellant to a heat shield heat exchanger disposed relative to a heat shield wall defining an outer surface of the vehicle, and a pump located along the second conduit. In such embodiments, the first conduit is configured to provide the first propellant to the pressure-fed propulsion engine at a first mass flow rate, the second conduit and the pump are configured to provide the second propellant to the heat shield heat exchanger at a second mass flow rate, and the second mass flow rate is substantially less than the first mass flow rate. A related method is also disclosed.

### CROSS-REFERENCE TO RELATED APPLICATION

The present application claims priority to U.S. Provisional Patent Application No. 63/561,260, filed on Mar. 4, 2024, the contents of which is herein incorporated by reference in its entirety.

### TECHNICAL FIELD

The present disclosure relates to a vehicle configured for in-space operations and atmospheric reentry operations. The present disclosure more particularly relates to a reusable vehicle for long-dwell payload hosting, orbital maneuvers, and downmass operations, and a related method.

### BACKGROUND

A combination of technical challenges has prevented prior development of a rapidly reusable vehicle that is capable of long duration orbital dwell operations, orbital maneuvers, on-orbit refueling, controlled atmospheric reentry, and precise landing. The technical challenges include: minimizing the mass of propellant tanks and the overall mass of the vehicle; maximizing the total delta-v available for orbital maneuvers; maintaining suitable propellant pressures during mission operations; preserving coolant for use during atmospheric reentry; providing a vehicle architecture that achieves aerodynamic stability during atmospheric reentry; providing a vehicle architecture that achieves favorable downmass payload capacity; providing a vehicle architecture that is scalable to various sizes to meet different mission and payload needs; and minimizing system complexity. Aspects of the present invention are directed to these and other problems.

### SUMMARY

According to an aspect of the present invention, a vehicle configured for in-space and atmospheric reentry operations includes a pressure-fed propulsion engine that uses cryogenic fuel and cryogenic oxidizer as propellants.

According to another aspect of the present invention, a vehicle includes a pressure-fed propulsion engine, a first conduit configured to provide a first propellant to the pressure-fed propulsion engine, a heat shield wall defining an outer surface of the vehicle, a heat shield heat exchanger disposed relative to the heat shield wall, a second conduit configured to provide a second propellant to the heat shield heat exchanger, and a pump located along the second conduit. The first conduit is configured to provide the first propellant to the pressure-fed propulsion engine at a first mass flow rate \dot{m}₁. The second conduit and the pump are configured to provide the second propellant to the heat shield heat exchanger at a second mass flow rate. The second mass flow rate \dot{m}₂ is substantially less than the first mass flow rate n.

According to another aspect of the present invention, a method for in-space and atmospheric reentry operation of a vehicle having a propulsion engine includes the steps of pressure feeding a cryogenic fuel to the propulsion engine and pressure feeding a cryogenic oxidizer to the propulsion engine.

In addition to, or as an alternative to, one or more of the features described above, further aspects of the present invention can include one or more of the following features, individually or in combination:
the vehicle excludes a turbopump;
the cryogenic fuel is liquid hydrogen and the cryogenic oxidizer is liquid oxygen;
the vehicle further includes a heat shield configured to define a windward side of the vehicle during travel in an atmospheric reentry phase of a flight trajectory, a heat exchanger disposed relative to the heat shield and having a coolant therein, the heat exchanger configured to transfer energy from the heat shield to the coolant to generate a heated fluid flow, and a tank pressure control system configured to adjust and/or maintain a pressure in a cryogenic fuel tank and/or a cryogenic oxidizer tank of the vehicle using at least a portion of the heated fluid flow;
the vehicle further includes a heat exchanger disposed relative to the pressure-fed propulsion engine and having a coolant therein, the heat exchanger configured to transfer energy from the pressure-fed propulsion engine to the coolant to generate a heated fluid flow, and a tank pressure control system configured to adjust and/or maintain a pressure in a cryogenic fuel tank and/or a cryogenic oxidizer tank of the vehicle using at least a portion of the heated fluid flow.
the vehicle is an upper stage rocket of a multi-stage rocket system;
the vehicle is a third stage rocket of a three-stage rocket system;
the first propellant is cryogenic fuel and the second propellant is cryogenic fuel;
respective magnitudes of the first mass flow rate \dot{m}₁ and the second mass flow rate \dot{m}₂ are such that

$$\frac{{\dot{m}}_{2}}{{\dot{m}}_{1} + {\dot{m}}_{2}} \leq x ,$$

where 0<x≤0.100;
respective magnitudes of the first mass flow rate \dot{m}₁ and the second mass flow rate \dot{m}₂ are such that

$$\frac{{\dot{m}}_{2}}{{\dot{m}}_{1} + {\dot{m}}_{2}} \leq x ,$$

where x is 0.010, 0.020, 0.030, 0.040, 0.050, 0.060, 0.070, 0.080, 0.090, or 0.100;
the vehicle further includes a fuel tank configured to store a fuel in fluid form, the first propellant is a first portion of the fuel stored in the fuel tank, and the second propellant is a second portion of the fuel stored in the fuel tank;
the fuel stored in the fuel tank is a cryogenic fuel, and the vehicle further includes an oxidizer tank configured to store a cryogenic oxidizer in fluid form and an oxidizer conduit configured to provide at least a portion of the cryogenic oxidizer to the pressure-fed propulsion engine;
the vehicle further includes a fuel tank configured to store a fuel in fluid form, a coolant tank configured to store a coolant in fluid form, the first propellant is at least a first portion of the fuel stored in the fuel tank, and the second propellant is at least a first portion of the coolant stored in the coolant tank;
the fuel tank includes a fuel cavity in which the fuel is stored, the coolant tank includes a coolant cavity in which the coolant is stored, and the fuel tank and the coolant tank are configured such that the fuel stored in the fuel cavity is physically separate from the coolant stored in the coolant cavity;
the coolant tank is positioned within the fuel cavity of the fuel tank;
the coolant tank is positioned outside the fuel cavity of the fuel tank;
the vehicle further includes an engine heat exchanger disposed relative to the pressure-fed propulsion engine, and the engine heat exchanger is located along the first conduit;
the first conduit is not in fluid communication with the second conduit;
the pump located along the second conduit is an electric pump;
the vehicle excludes a pump in fluid communication with the first conduit;
the heat shield heat exchanger is configured to transfer energy from the heat shield wall to the second propellant received from the second conduit to generate a heated fluid flow;
the vehicle further includes a fuel tank configured to store a fuel in fluid form, a first heated fluid conduit between the second conduit and the fuel tank, and a flow controller configured to selectively pass at least a first portion of the heated fluid flow from the second conduit to the first heated fluid conduit for transport to the fuel tank;
the vehicle further includes an exogenous pressurization subsystem with a helium vessel configured to store helium coolant in gaseous form, a helium conduit between the flow controller and an ullage space of the fuel tank, and a helium flow controller configured to receive helium coolant from the helium vessel, and the helium flow controller is configured to selectively pass at least a first portion of the helium coolant received from the helium vessel to the helium conduit for transport to the fuel tank;
the vehicle further includes an oxidizer tank configured to store a cryogenic oxidizer in fluid form and an oxidizer conduit configured to provide at least a portion of the cryogenic oxidizer to the pressure-fed propulsion engine, and the helium vessel of the exogenous pressurization subsystem is positioned within the oxidizer tank;
the vehicle further includes a control thruster and a second heated fluid conduit between the second conduit and the control thruster, and the flow controller is configured to selectively pass at least a second portion of the heated fluid flow from the second conduit to the second heated fluid conduit for transport to the control thruster;
the steps of pressure feeding the cryogenic fuel and pressure feeding the cryogenic oxidizer do not involve use of a pump;
the step of pressure feeding the cryogenic fuel to the propulsion engine involves delivering the cryogenic fuel to the propulsion engine via a first conduit, and the method further includes delivering a coolant to a heat shield heat exchanger disposed relative to a heat shield wall that defines an outer surface of the vehicle;
the coolant and the cryogenic fuel are a same material;
the step of delivering the coolant to the heat shield heat exchanger involves delivering the coolant to the heat shield heat exchanger via a second conduit that is not in fluid communication with the first conduit;
the cryogenic fuel is delivered to the propulsion engine via the first conduit at a first mass flow rate \dot{m}₁, the coolant is delivered to the heat shield heat exchanger via the second conduit at a second mass flow rate \dot{m}₂, and the second mass flow rate \dot{m}₂ is substantially less than the first mass flow rate \dot{m}₁; and
the step of delivering the coolant to the heat shield heat exchanger involves use of a pump that is in fluid communication with the second conduit.

These and other aspects of the present invention will become apparent in light of the drawings and detailed description provided below.

### BRIEF DESCRIPTION OF THE DRAWINGS

FIG. 1 is an elevation view of a multi-stage rocket system that includes the present vehicle in the form of a third stage rocket. In FIG. 1, the vehicle is stowed within the second stage rocket and thus is not visible.

FIG. 2 is an exploded elevation view of the multi-stage rocket system of FIG. 1, which includes a first stage rocket, a second stage rocket, and the present vehicle in the form of a third stage rocket.

FIG. 3 is an elevation view of the vehicle of FIG. 2.

FIG. 4 is a partial perspective view of an embodiment of the present vehicle in which the fuel tanks store liquid methane and the oxidizer tank stores liquid oxygen.

FIG. 5 is a partial perspective view of an embodiment of the present vehicle in which the fuel tanks store liquid propylene and the oxidizer tank stores nitrous oxide.

FIG. 6 plots changes in hydrogen density as a function of temperature for various pressures.

FIG. 7 plots changes in oxygen density as a function of temperature for various pressures.

FIG. 8 plots the dry mass of the vehicle of FIG. 2 as a function of the maximum expected operating pressure of the propellant tanks onboard the vehicle (the “tank MEOP”).

FIG. 9 plots the on-orbit delta-v of the vehicle of FIG. 2 as a function of the tank MEOP, and plots the mission duration of the vehicle as a function of the tank MEOP in three different scenarios.

FIG. 10 provides a table showing performance capabilities for small, medium, and large variants of the vehicle of FIG. 2.

FIG. 11 schematically illustrates an embodiment of the vehicle in which the propellant tanks are self-pressurized.

FIG. 12 schematically illustrates an embodiment of the vehicle in which at least one tank storing coolant for the actively-cooled heat shield of the vehicle is self-pressurized.

FIG. 13 schematically illustrates components of the vehicle of FIGS. 2 and 3, in which a first conduit is configured to provide propellant to the pressure-fed propulsion engine a first mass flow rate \dot{m}₁, a second conduit and an electric pump are configured to provide propellant to a heat shield heat exchanger at a second mass flow rate \dot{m}₂, and the second mass flow rate \dot{m}₂ is substantially less than the first mass flow rate \dot{m}₁.

FIG. 14 schematically illustrates components of an embodiment of a vehicle that is identical to the embodiment of FIG. 13 except the engine heat exchanger is located along the second conduit downstream of the heat shield heat exchanger rather than upstream of the heat shield heat exchanger.

FIG. 15 schematically illustrates components of an embodiment of a vehicle that is identical to the embodiment of FIG. 13 except the vehicle includes a separate coolant tank that stores the coolant for the actively-cooled heat shield.

FIG. 16 schematically illustrates components of an embodiment of a vehicle that is identical to the embodiment of FIG. 15 except the engine heat exchanger is located along the second conduit downstream of the heat shield heat exchanger rather than upstream of the heat shield heat exchanger.

FIG. 17 schematically illustrates the flight trajectory of the multi-stage rocket system of FIGS. 1 and 2.

FIG. 18 schematically illustrates the vehicle of FIGS. 2, 3, and 13 in a first operating mode during a maneuver from a first orbital altitude to a second orbital altitude as shown in FIG. 17.

FIG. 19 schematically illustrates the vehicle of FIGS. 2, 3, and 13 in a second operating mode during a long duration on-orbit dwell operation as shown in FIG. 17.

FIG. 20 schematically illustrates the vehicle of FIGS. 2, 3, and 13 in a third operating mode during atmospheric reentry as shown in FIG. 17.

FIG. 21 schematically illustrates the vehicle of FIGS. 2, 3, and 13 in a fourth operating mode during propulsive landing as shown in FIG. 17.

### DETAILED DESCRIPTION

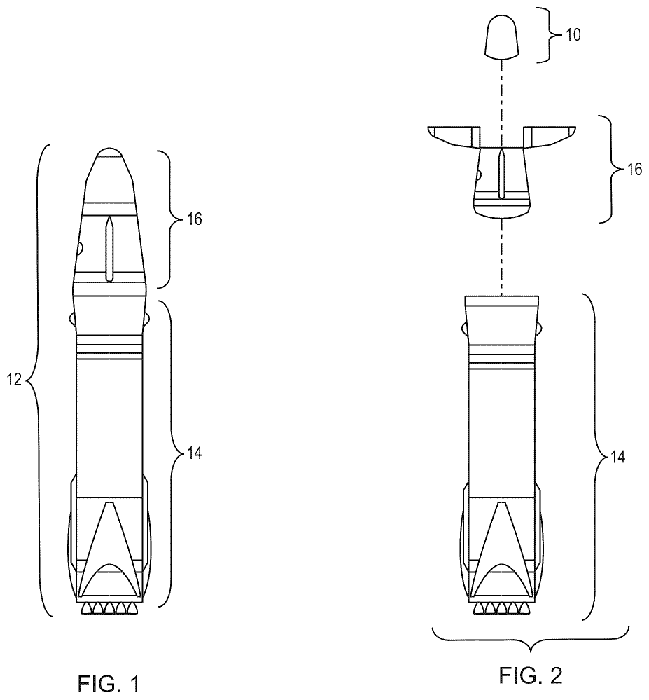

Referring to FIGS. 1-3, the present disclosure describes a space vehicle 10 derived from Applicant's prior vehicle architecture disclosed in International Patent Application Nos. PCT/US2020/048178, PCT/US2020/048226, PCT/US2022/071686, PCT/US2022/071688, PCT/US24/41511, and PCT/US24/55143 and U.S. Provisional Patent Application Nos. 63/518,790 and 63/597,222, the contents of which are incorporated by reference herein in their entirety. The present disclosure also describes a related method.

The present vehicle 10 uses advantages of Applicant's prior vehicle architecture and modifies them to enable missions that require a long duration, mobile, and reusable space vehicle to host payloads on orbit before returning them rapidly and precisely to Earth. The modifications described herein enable the vehicle 10 to achieve: 1) a total delta-v sufficient to perform orbital maneuvers for a payload with a mass that is greater than 1,000 kg; 2) on-orbit dwell for long durations (e.g., multiple days, weeks, months); 3) rapid return from high energy orbits; and 4) precise, powered landings.

Referring to FIGS. 1-3, the vehicle 10 is a rocket, a missile, a spacecraft, an aircraft, or another vehicle designed for travel (e.g., flight) up to at least supersonic speeds (e.g., supersonic speeds, hypersonic speeds, reentry speeds, etc.) in atmospheric, sub-orbital, orbital, extraterrestrial, and/or outer space environments. In some embodiments, the vehicle 10 is an upper stage rocket of a multi-stage rocket system 12 that also includes at least one lower stage rocket 14, 16. In the embodiments illustrated in FIGS. 1-5, the vehicle 10 is a third stage rocket of a multi-stage rocket system 12 that also includes a first stage rocket 14 and a second stage rocket 16. In other embodiments, the vehicle is a second stage rocket of a multi-stage rocket system that also includes a first stage rocket.

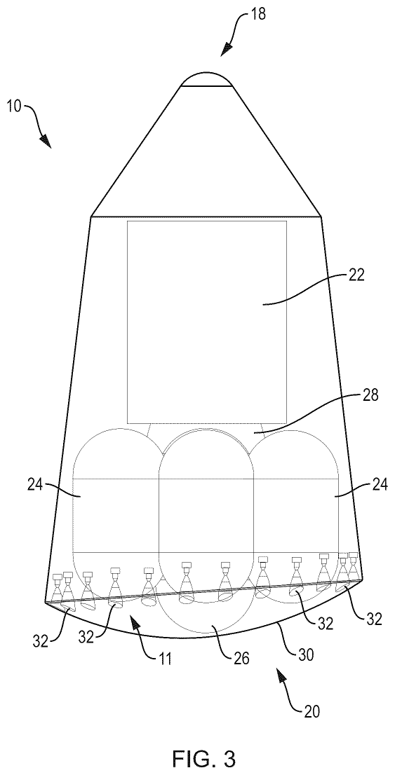

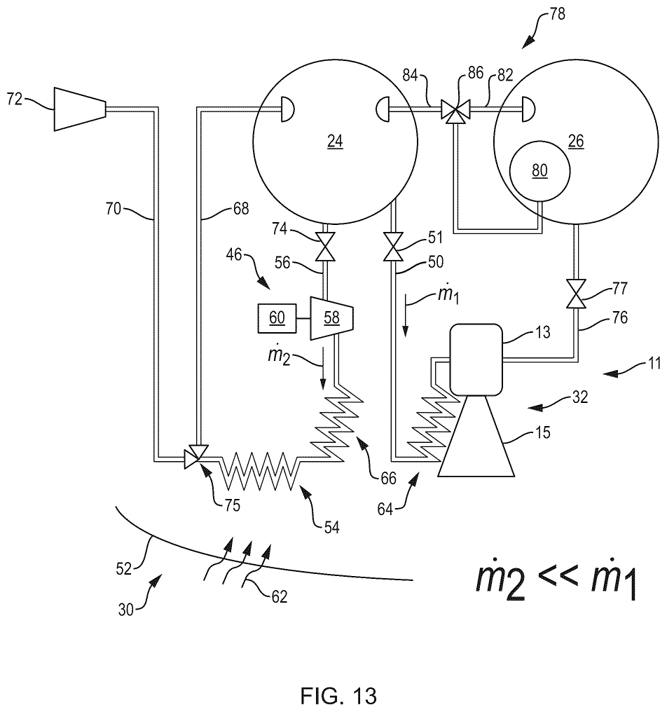

Referring to FIG. 3, in the illustrated embodiment, the vehicle 10 includes a main body defining a nose 18 at a forward end of the vehicle 10, a base 20 defining an aft end of the vehicle 10, and a sidewall extending in a direction between the nose 18 and the base 20. The main body houses a deployable payload 22, at least one fuel tank 24, at least one oxidizer tank 26, and a payload attach fitting 28. The vehicle 10 includes an actively-cooled heat shield 30 at the base 20, and a reaction control system (not shown) at the sidewall. The vehicle 10 includes a propulsion engine 11 that is at least partially recessed into the heat shield 30 and the base 20. The engine 11 has a “plug cluster” configuration in which a plurality of discrete combustion chambers 13 (see FIGS. 13-16) are spaced relative to one another, and a plurality of discrete initial nozzle portions 15 (see FIGS. 13-16) are spaced relative to one another. Each combustion chamber 13 is configured to receive fuel from the fuel tank 24 and oxidizer from the oxidizer tank 26. The combination of fuel and oxidizer is combusted in the combustion chamber 13 to generate gas. Each initial nozzle portion 15 is located relative to a corresponding combustion chamber 13 and is configured to exhaust gas exiting the respective combustion chamber 13. Each combustion chamber 13 and initial nozzle portion 15 pair is referred to herein as a “thruster 32.”

The vehicle 10 has a profile that is modified relative to that of Applicant's prior vehicle architecture. The base 20 of the present vehicle is relatively wider, and the height is relatively shorter, to lower the center of gravity and increase the aerodynamic stability during atmospheric reentry of the vehicle 10. This enables the vehicle 10 to accommodate a significant increase (e.g., at least one order of magnitude) in downmass payload capacity relative to Applicant's prior vehicle architecture. In the embodiments illustrated in FIGS. 3-5, the heat shield 30 at the base 20 of the vehicle 10 is skewed relative to the main body of the vehicle 10 as disclosed in International Patent Application Nos. PCT/US2022/071686, PCT/US24/41511, and PCT/US24/55143, for example. In other embodiments not shown in the drawings, the heat shield 30 is not skewed relative to the main body of the vehicle 10. In such embodiments, the vehicle 10 has an axisymmetric shape, and the centerline of the heat shield is aligned with the centerline of the main body.

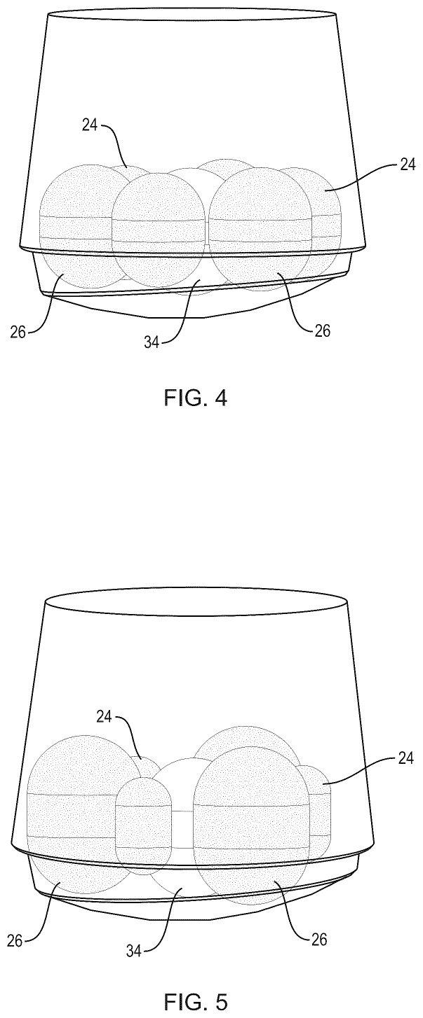

The vehicle 10 also differs from Applicant's prior vehicle architecture in that it excludes a turbopump-fed engine in favor of a pressure-fed engine 11. In the illustrated embodiments, the fuel tanks 24 and oxidizer tanks 26 are high-pressure tanks that deliver propellants to the engine 11. Unlike prior art space vehicles using pressure-fed engines, the present vehicle 10 uses cryogenic fuel (e.g., liquid hydrogen, liquid methane, liquid propylene) and cryogenic oxidizer (e.g., liquid oxygen) as propellants for its pressure-fed engine 11. This requires the propellant tanks 24, 26 to be capable of handling much higher pressures (and as such be much heavier) than the relatively low-pressure tanks that are used with turbopump-fed engines. In the embodiment of FIG. 3, the fuel tanks 24 store liquid hydrogen and the oxidizer tank 26 stores liquid oxygen. In the embodiment of FIG. 4, the fuel tanks 24 store liquid methane and the oxidizer tank 26 stores liquid oxygen. In the embodiment of FIG. 5, the fuel tanks 24 store liquid propylene and the oxidizer tank 26 stores nitrous oxide.

In some embodiments (e.g., FIGS. 3-5), the active-cooled heat shield 30 is also pressure-fed with coolant. In some embodiments (e.g., FIG. 3), the cryogenic fuel stored in the fuel tanks 24 also functions as the coolant for the actively-cooled heat shield 30 and it is pressure-fed to the heat shield 30 without the use of a pump. In other embodiments (e.g., FIGS. 4 and 5), the vehicle 10 includes at least one tank 34 of liquid water or another fluid (e.g., helium) that serves as the coolant for the active-cooled heat shield 30 and the liquid water or other fluid is pressure-fed to the heat shield 30 without the use of a pump.

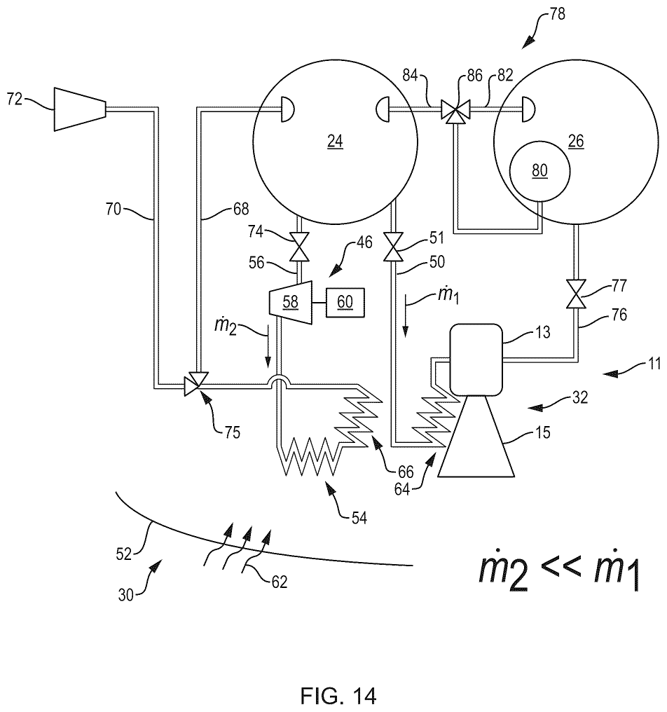

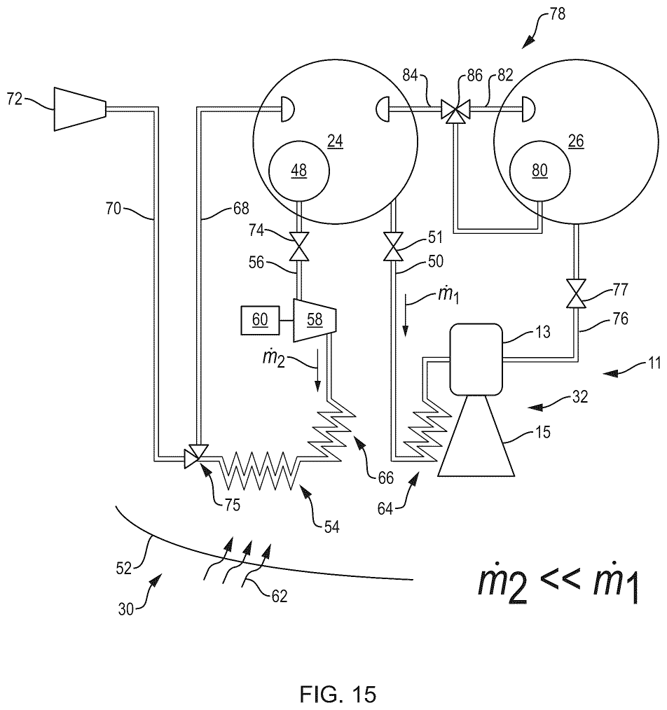

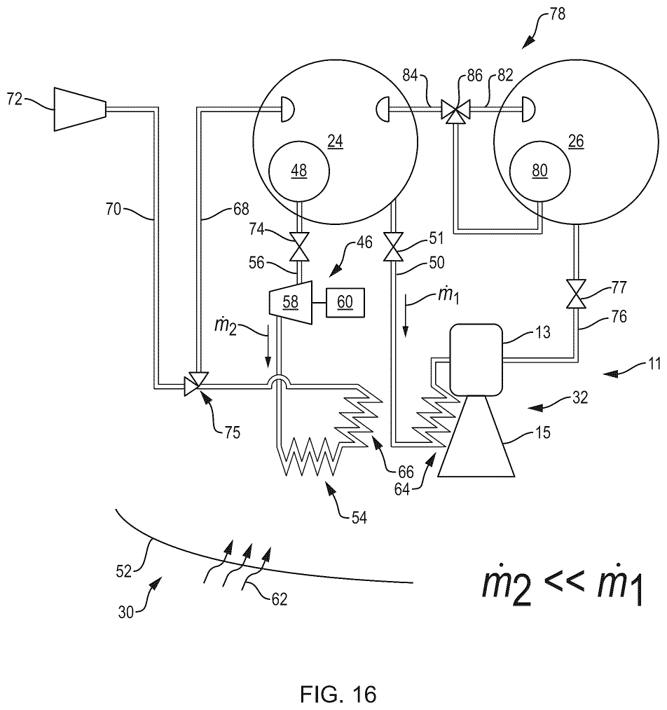

In other embodiments (e.g., FIGS. 13-16), the vehicle 10 includes at least one pump 46 that aids in feeding coolant to the heat shield 30, as will be described in more detail below. In some such embodiments (e.g., FIGS. 13 and 14), the cryogenic fuel stored in the fuel tanks 24 functions as the coolant for the actively-cooled heat shield 30. In other embodiments (e.g., FIGS. 15 and 16), the vehicle 10 includes at least one coolant tank 48 that stores a coolant (e.g., helium) that serves as the coolant for the actively-cooled heat shield 30 and is fed to the heat shield 30 by the pump 46.

Referring to FIGS. 3-5, in some embodiments, the vehicle 10 also differs from Applicant's prior vehicle architecture in that it uses a nested header tank architecture and eliminates main propellant tanks. The nested tanks 24, 26, 34 have inherently higher insulation due to the protection from direct solar radiation and can be further insulated with multi-layer insulation (MLI) to further decrease the heat load on orbit. The tanks 24, 26, 34 are sized to accomplish both on-orbit maneuver and atmospheric reentry. In some embodiments, the tanks 24, 26, 34 account for roughly one third of the dry mass of the vehicle 10. This architecture would not be possible in a traditional launch vehicle since the propellant tank mass is too high. However, the penalty in mass efficiency still trades favorably for the present downmass-optimized vehicle 10 due to its benefits for on-orbit dwell duration and aerodynamic stability during reentry.

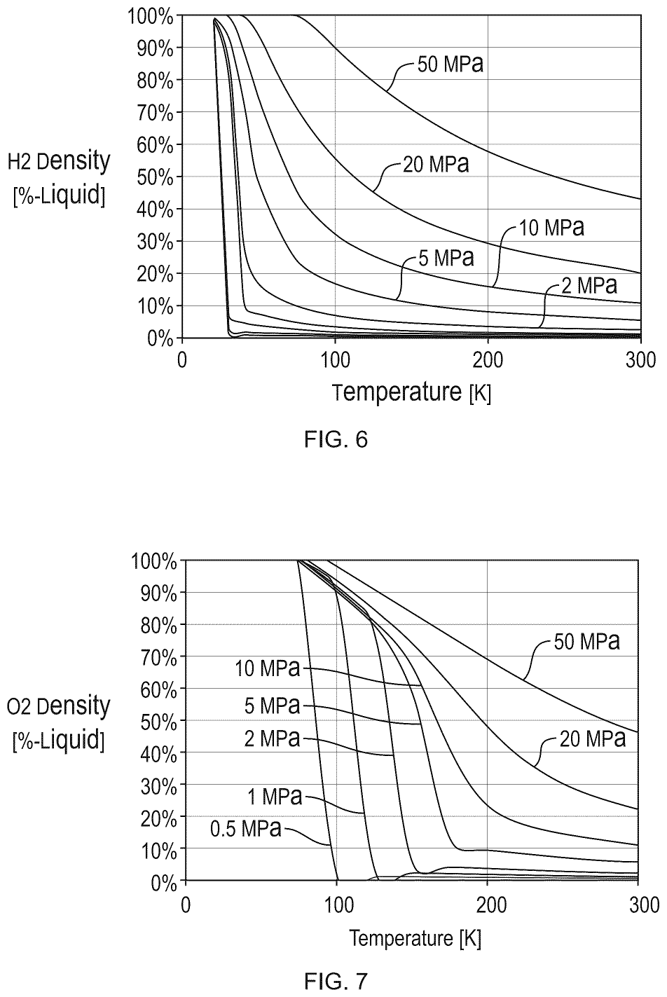

In some embodiments, the high-pressure propellant tanks 24, 26 of the present vehicle 10 enable the vehicle to dwell for extended periods on orbit without venting propellant boiloff, thus preserving maneuverability and reentry coolant. In the embodiment of FIG. 3, the high specific heat capacity of hydrogen allows the hydrogen fuel tanks 24 to absorb heat leaked into the tanks 24 with little temperature change. FIGS. 6 and 7 depict the hydrogen and oxygen density curves as functions of temperature for various pressures. For the amount of hydrogen required for entry, descent, and landing, it will take at least multiple days to raise the propellant temperature to the maximum pressure limit, which will allow for long duration dwell operations.

The high-pressure propellant tanks 24, 26 of the present vehicle 10 provide several additional benefits, including: 1) elimination of engine turbopumps resulting in fewer moving parts, less complexity, and higher reliability; 2) elimination or mass reduction of pressurization systems and pressurant collapse issues, and consumables; 3) elimination of engine purge systems and consumables; 4) elimination of engine chill times and consumables; 5) elimination of two-phase propellant issues such as stratification and slosh; 6) enabling addition of pressure-fed hot gas (bi-propellant) reaction control thrusters for unfettered maneuverability; and 7) enabling on-orbit refueling ease of concept of operations (CONOPs) and systems. Regarding the last item, it is noted that all on-orbit refueling operations to date have been conducted with self-pressurizing propellants rather than two-phase cryogenic liquids.

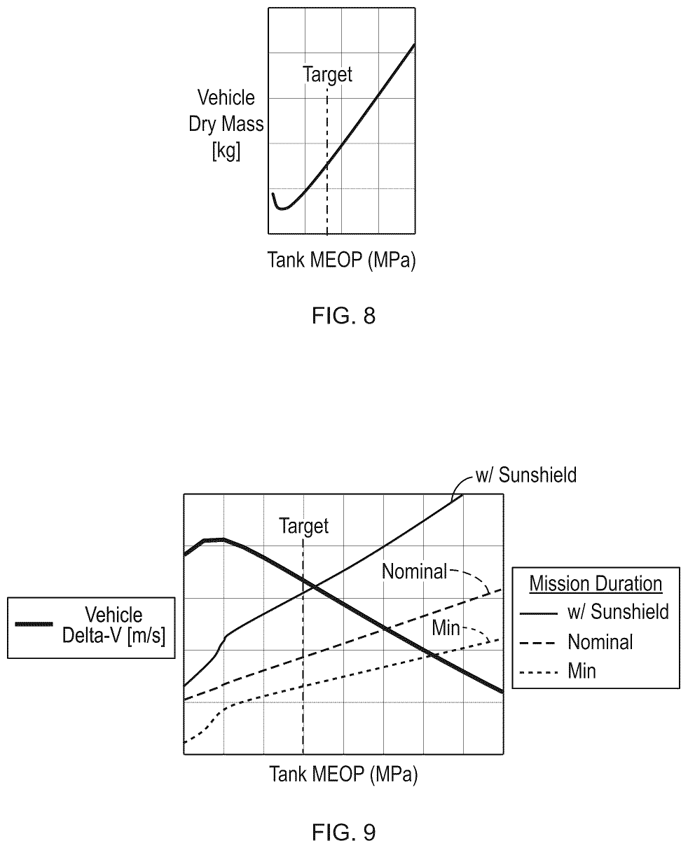

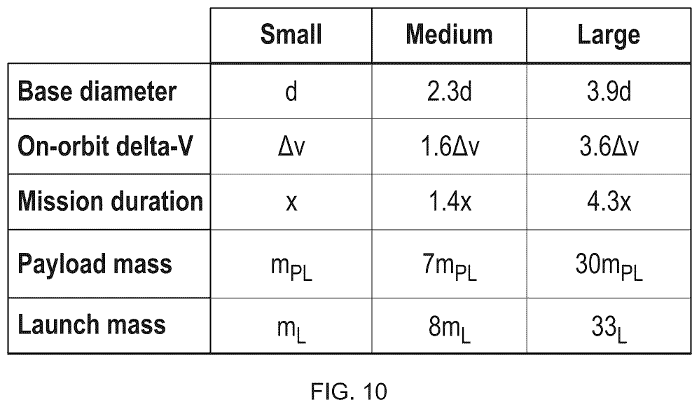

The high-pressure propellant tanks 24, 26 of the present vehicle 10 have a maximum expected operating pressure (MEOP). The higher tank pressure allows for the propellants to be stored for longer durations. Initially, propellants will be loaded into the tanks 24, 26 as saturated fluid at atmospheric pressure. Heat absorbed into the propellant tanks 24, 26 during the mission causes both the temperature and pressure to rise. Any pressure rise above MEOP will require the tanks 24, 26 to be vented, either by expending propellant with a maneuver or otherwise expelling it overboard (e.g., through zero-thrust vents). Therefore, the higher the MEOP, the longer the tank 24, 26 is allowed to rise in pressure before needing to vent. The drawback is that tank mass (and thus vehicle dry mass) increases with MEOP (see, e.g., FIG. 8), which impacts both the launch mass and maximum vehicle maneuverability and delta-v capability. Further, because the engine 11 is pressure-fed, the thrust of the engine increases with the pressures of the propellant tanks 24, 26. FIG. 9 shows the vehicle on-orbit delta-v (thick line) and mission duration (thin lines). The short-dash thin line (labeled “Min”) depicts a scenario in which all the delta-v is expended at the start of the mission. The long-dash thin line (labeled “Nominal”) depicts a scenario in which the on-orbit delta-v is expended at a distributed rate across the mission duration. The solid thin line depicts a scenario in which a sunshield is deployed to shield the main body of the vehicle 10 from sunlight during on-orbit operations.

Another advantage of the present design is the capability to scale the vehicle 10 to various sizes to meet different mission and payload needs. This is enabled by eliminating the turbomachinery, which would otherwise require a large engineering effort to redesign, test, and qualify for any size change. FIG. 10 provides a table showing performance capabilities for small, medium, and large variants of the vehicle 10.

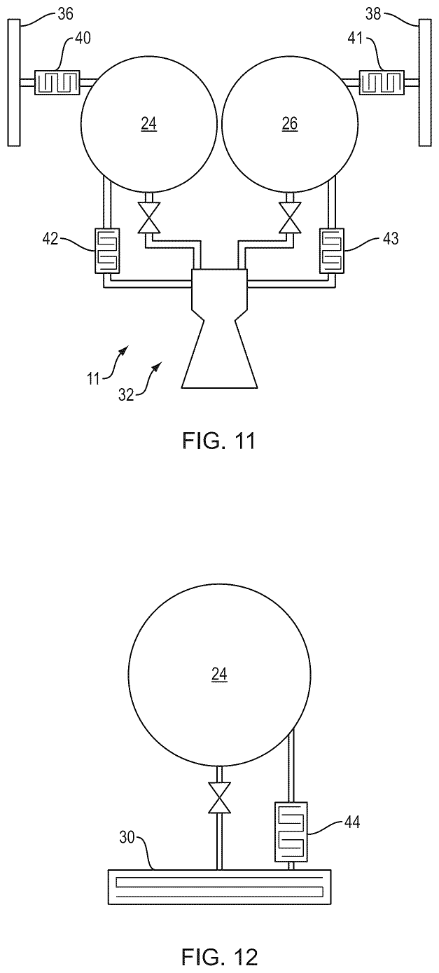

Referring to FIG. 11, in some embodiments, the propellant tanks 24, 26 of the vehicle 10 are self-pressurized. That is, the vehicle 10 is configured to use heat from the engine 11 and/or at least one external source 36, 38 to selectively pressurize the propellant tanks 24, 26 (e.g., to increase and/or maintain a tank pressure at a predetermined pressure). In such embodiments, the vehicle 10 additionally includes at least one heat exchanger 40, 41 that is configured to efficiently transfer heat from the external source 36, 38 to the respective tank 24, 26, and/or at least one heat exchanger 42, 43 that is configured to efficiently transfer heat from the engine 11 to a respective tank 24, 26. In some embodiments, the external source 36, 38 is the heat shield 30 at the base 20 of the vehicle 10. In some such embodiments, the vehicle 10 is configured to convert heat received at the heat shield 30 from an orbital environment (e.g., via exposure to sunlight) and/or an atmospheric reentry environment (e.g., via exposure to high enthalpy flow) into energy for pressuring the tanks 24, 26.

Referring to FIG. 12, in some embodiments, the vehicle 10 is additionally or alternatively configured such that the at least one tank 24 storing coolant for the actively-cooled heat shield 30 of the vehicle 10 is self-pressurized. That is, the vehicle 10 is configured to use heat from at least one external source to selectively pressurize the coolant tank 24 (e.g., to increase and/or maintain a tank pressure at a predetermined pressure). In such embodiments, the vehicle 10 additionally includes at least one heat exchanger 44 that is configured to efficiently transfer heat from the external source to the coolant tank 24. In some embodiments, the external source is the heat shield 30 at the base 20 of the vehicle 10. In some such embodiments, the vehicle 10 is configured to convert heat received on the heat shield 30 from an orbital environment (e.g., via exposure to sunlight) and/or an atmospheric reentry environment (e.g., via exposure to high enthalpy flow) into energy for pressuring the tank 24.

Referring to FIGS. 13-16, in some embodiments, the vehicle 10 includes the pressure-fed propulsion engine 11, a first conduit 50 configured to provide a first propellant (e.g., cryogenic propellant) to the engine 11, a heat shield wall 52 defining an outer surface of the vehicle 10 (e.g., an outer surface of the heat shield 30 at the base 20 of the vehicle 10), a heat shield heat exchanger 54 disposed relative to the heat shield wall 52, a second conduit 56 configured to provide a second propellant (e.g., cryogenic propellant) to the heat shield heat exchanger 54, and a pump 46 located along the second conduit 56. In some such embodiments, the first conduit 50 is configured to provide the first propellant to the engine 11 at a first mass flow rate \dot{m}₁, the second conduit 56 and the pump 46 are configured to provide the second propellant to the heat shield heat exchanger 54 at a second mass flow rate \dot{m}₂, and the second mass flow rate \dot{m}₂ is substantially less than the first mass flow rate \dot{m}₁. In some embodiments, the respective magnitudes of the first mass flow rate \dot{m}₁ and the second mass flow rate \dot{m}₂ are such that

$$\frac{{\dot{m}}_{2}}{{\dot{m}}_{1} + {\dot{m}}_{2}} \leq x ,$$

where 0<x≤0.100. In some embodiments, x is greater than zero and less than or equal to 0.090, 0.080, 0.070, 0.060, 0.050, 0.040, 0.030, 0.020, or 0.010.

In some embodiments (e.g., FIGS. 13 and 14), the first propellant provided to the engine 11 via the first conduit 50 (e.g., ducting, tubing, etc.) is a first portion of the fuel (e.g., liquid hydrogen) stored in the fuel tank 24 of the vehicle 10, and the second propellant provided to the heat shield heat exchanger 54 via the second conduit 56 (e.g., ducting, tubing, etc.) is a second portion of the fuel stored in the fuel tank 24. In other embodiments (e.g., FIGS. 15 and 16), the vehicle 10 further includes a coolant tank 48 configured to store a coolant (e.g., a cryogenic coolant that is the same or different than the fuel in the fuel tank 24) for use in cooling the heat shield 30. In some such embodiments, the first propellant provided to the engine 11 via the first conduit 50 is at least a first portion of the fuel stored in the fuel tank 24, and the second propellant provided to the heat shield heat exchanger 54 via the second conduit 56 is at least a first portion of the coolant stored in the coolant tank 48. In some embodiments (e.g., FIGS. 15 and 16), the coolant tank 48 is positioned within the fuel tank 24. In such embodiments, the fuel tank 24 includes a fuel cavity in which the fuel is stored, the coolant tank 48 includes a coolant cavity in which the coolant is stored, and the fuel tank 24 and the coolant tank 48 are configured such that the fuel stored in the fuel cavity is physically separate from the coolant stored in the coolant cavity. In other embodiments (not shown), the coolant tank 48 is positioned outside the fuel cavity of the fuel tank 24. In some embodiments, the coolant tank 48 is filled with the coolant at the start of the mission.

In other embodiments, the coolant tank 48 is empty at the start of the mission and is filled with the coolant (e.g., a portion of the fuel from the fuel tank 24) only after the start of the mission.

In the embodiments illustrated in FIGS. 13-16, the vehicle 10 further includes a fuel flow controller 51 configured to selectively pass fuel from the fuel tank 24 to the first conduit 50 for transport to the engine 11. The fuel flow controller 51 includes one or more flow components (e.g., one or more conduits, valves, regulators, vents, orifices, sensors, transducers, flow meters, pressure meters, diffusers, etc.).

In the illustrated embodiments of FIGS. 13-16, the pump 46 is in fluid communication with the second conduit 56 and is configured to selectively increase at least one flow parameter (e.g., pressure, velocity, etc.) of the second propellant flowing toward the heat shield heat exchanger 54 via the second conduit 56. The pump 46 includes at least a fluid contact component 58 and a mover 60 configured to selectively move the fluid contact component 58 such that fluid is transferred from an inlet of the pump 46 to an outlet of the pump 46. In the illustrated embodiments, the pump 46 is an electrically-powered centrifugal pump in which the mover 60 is a battery-powered electric motor and the fluid contact component 58 is an impeller that is selectively rotated by the electric motor to move fluid from the inlet of the pump 46 (at an upstream position along the second conduit 56) to the outlet of the pump 46 (at a downstream position along the second conduit 56). In other embodiments, the pump 46 is a centrifugal pump, a positive-displacement pump, an axial flow pump, a membrane pump, a screw pump, or another type of pump. The functionality of the pump 46 can be implemented using known components, including shafts, rotors, housings, conduits, seals, bearings, couplings, valves, etc. In the illustrated embodiments, the first conduit 50 is not in fluid communication with the second conduit 56, and no pump is in fluid communication with the first conduit 50. As such, the engine 11 is entirely pressure-fed and does not rely on a turbopump or any other pump for delivery of the fuel and the oxidizer from the respective tanks 24, 26 to the combustion chamber 13 of each thruster 32.

In the illustrated embodiments of FIGS. 13-16, the heat shield heat exchanger 54 is configured to transfer energy 62 from the heat shield wall 52 to the second propellant received from the second conduit 56 to generate a heated fluid flow. The heat shield wall 52 is a durable metallic wall that excludes ablative materials. The flow of the second propellant through the heat shield heat exchanger 54 maintains acceptable temperatures on the heat shield 30 during operation of the vehicle 10 in a base-first atmospheric reentry trajectory, for example.

In some embodiments, the vehicle 10 further includes at least one engine heat exchanger 64, 66 disposed relative to the engine 11 (e.g., disposed relative to the combustion chamber 13 and/or the initial nozzle portion 15 of each thruster 32). In the illustrated embodiments of FIGS. 13-16, the vehicle 10 further includes a first engine heat exchanger 64 located along the first conduit 50 and a second engine heat exchanger 66 located along the second conduit 56. The first engine heat exchanger 64 is configured to transfer energy from the engine 11 to the first propellant flowing through the first conduit 50, and the second engine heat exchanger 66 is configured to transfer energy from the engine 11 to the second propellant flowing through the second conduit 56. In some embodiments (e.g., FIGS. 13 and 15), the second engine heat exchanger 66 is located along the second conduit 56 upstream of the heat shield heat exchanger 54. In other embodiments (e.g., FIGS. 14 and 16), the second engine heat exchanger 66 is located along the second conduit 56 downstream of the heat shield heat exchanger 54. The flow of respective fluids through the first and second engine heat exchangers 64, 66 maintains acceptable temperatures on the engine 11 during operation thereof.

In some embodiments, the vehicle 10 further includes at least one heated fluid conduit 68, 70 configured to receive heated fluid flow from the second conduit 56 and transport the heated fluid flow to a tank (e.g., for pressurization of the tank), a thruster (e.g., for attitude control or other control), and/or another auxiliary system (e.g., for power use). In the illustrated embodiments of FIGS. 13-16, the vehicle 10 includes a first heated fluid conduit 68 between the second conduit 56 and the fuel tank 24, and a second heated fluid conduit 70 between the second conduit 56 and a control thruster 72 (e.g., an axial control thruster pointed in a same direction as the thrusters, an attitude control thruster pointed in a direction that is offset relative to the axial direction of the thrusters, etc.). The vehicle 10 includes a first flow controller 74 configured to selectively pass fluid from the fuel tank 24 and/or the coolant tank 48 to the second conduit 56. The vehicle 10 further includes a second flow controller 75 configured to selectively pass heated fluid flow from the second conduit 56 to the first heated fluid conduit 68 for transport to the fuel tank 24 for pressurization of the fuel tank 24, and selectively pass heated fluid flow from the second conduit 56 to the second heated fluid conduit 70 for transport to the control thruster 72. The first and second flow controllers 74, 75 each include one or more flow components (e.g., one or more conduits, valves, regulators, vents, orifices, sensors, transducers, flow meters, pressure meters, diffusers, etc.). Although the illustrated embodiments show the control thruster 72 configured to receive fuel from the fuel tank 24 or coolant from the coolant tank 48, in other embodiments the control thruster 72 is additionally or alternatively configured to receive oxidizer from the oxidizer tank 26. In some embodiments, the control thruster 72 is configured to receive both fuel and oxidizer and to combust the fuel and oxidizer to generate a gas that is exhausted from the control thruster 72.

In the embodiments illustrated in FIGS. 13-16, the vehicle 10 includes an oxidizer tank 26 configured to store a cryogenic oxidizer (e.g., liquid oxygen) in fluid form, and an oxidizer conduit 76 configured to provide at least a portion of the cryogenic oxidizer to the engine 11. The vehicle 10 further includes an oxidizer flow controller 77 configured to selectively pass oxidizer from the oxidizer tank 26 to the oxidizer conduit 76 for transport to the engine 11. The oxidizer flow controller 77 includes one or more flow components (e.g., one or more conduits, valves, regulators, vents, orifices, sensors, transducers, flow meters, pressure meters, diffusers, etc.).

In some embodiments, the vehicle 10 further includes an exogenous pressurization subsystem 78 that includes a helium vessel 80 configured to store helium coolant in gaseous form, one or more helium conduits 82, 84 in fluid communication with the helium vessel 80, and a helium flow controller 86 configured to selectively pass the helium coolant from the helium vessel 80 to the one or more helium conduits 82, 84 for pressurizing one or more tanks. In the illustrated embodiments of FIGS. 13-16, the helium flow controller 86 is configured to selectively pass at least a first portion of the helium coolant received from the helium vessel 80 to a first helium conduit 86 for transport to the fuel tank 24, and selectively pass at least a second portion of the helium coolant received from the helium vessel 80 to a second helium conduit 84 for transport to the oxidizer tank 26. In some embodiments, the exogenous pressurization subsystem 78 further includes one or more heaters (e.g., heat exchangers, gas generators, etc.) positioned along the one or more helium conduits 82, 84 for heating the helium coolant flowing therethrough. In the illustrated embodiments of FIGS. 13-16, the helium vessel 80 of the exogenous pressurization subsystem 78 is positioned with the oxidizer tank 26. In other embodiments, the helium vessel 80 is positioned outside of the oxidizer tank 26. The helium flow controller 86 includes one or more flow components (e.g., one or more conduits, valves, regulators, vents, orifices, sensors, transducers, flow meters, pressure meters, diffusers, etc.).

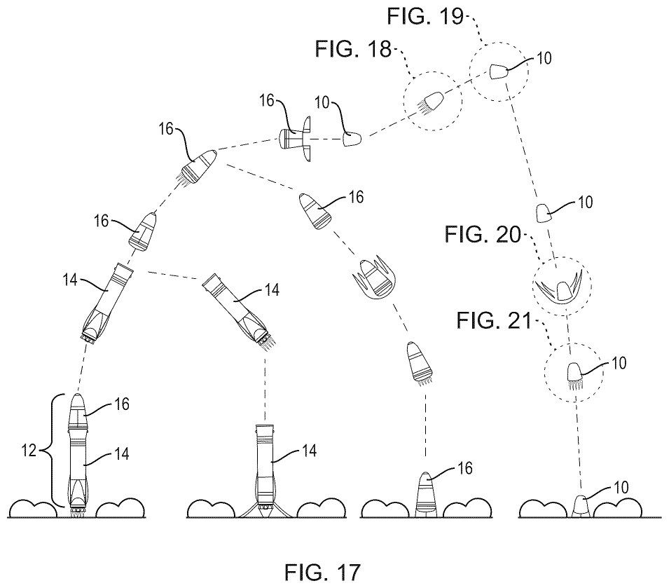

Referring to FIG. 17, in the illustrated embodiment, the vehicle 10 can be operated in several different modes across different phases of a flight trajectory. During liftoff and initial ascent phases, the vehicle 10 is stowed within the second stage rocket 16, which itself is fixed to the forward end of the first stage rocket 14 that propels the rocket system 12 toward a first stage separation altitude. During the liftoff and initial ascent phases, the engine and actively-cooled heat shield 30 of the vehicle 10 are not operational. When the rocket system 12 is at or near the first stage separation altitude, the second stage rocket 16 separates from the first stage rocket 14 and begins a final ascent phase during which the engine of the second stage rocket 16 is operated to propel the second stage rocket 16 (and the vehicle 10 stowed therein) to a second stage separation altitude. When the second stage rocket 16 is at or near the second stage separation altitude, the vehicle 10 is deployed from the second stage rocket 16.

After the first stage rocket 14 separates from the second stage rocket 16, operation of the engine of the first stage rocket 14 is paused and the first stage rocket 14 begins a descent phase. The first stage rocket 14 descends until a terminal descent altitude is reached. Once the first stage rocket 14 reaches the terminal descent altitude, a propulsive landing phase begins during which the engine of the first stage rocket 14 is operated to controllably land the first stage rocket 14 at a precise location where it can be retrieved and prepped for reuse.

After the second stage rocket 16 deploys the vehicle 10 (e.g., the third stage rocket), the second stage rocket 16 begins an atmospheric reentry phase during which the heat shield and the base of the second stage rocket 16 defines the windward side of the second stage rocket 16. During the atmospheric reentry phase, operation of the engine is paused and the heat shield of the second stage rocket 16 is actively cooled to protect the second stage rocket 16 from the harsh atmospheric reentry environment. The second stage rocket 16 descends in this manner until a terminal descent altitude is reached. Once the second stage rocket 16 reaches the terminal descent altitude, a propulsive landing phase begins during which the second stage rocket 16 engine is operated to controllably land the second stage rocket 16 at a precise location where it can be retrieved and prepped for reuse.

After the vehicle 10 separates from the second stage rocket 16, the vehicle 10 may dwell and/or maneuver in one or more orbits (e.g., a geostationary transfer orbit (GTO), a low Earth orbit (LEO), etc.). After completion of a predetermined mission, and/or after receipt of return instructions received from a ground station, the vehicle 10 initiates its return to Earth. The vehicle 10 begins an atmospheric reentry phase during which the heat shield and the base of the vehicle 10 defines the windward side of the vehicle 10. During the atmospheric reentry phase, operation of the pressure-fed engine is paused and the heat shield of the second stage rocket 16 is actively cooled to protect the vehicle 10 from the harsh atmospheric reentry environment. The vehicle 10 descends in this manner until a terminal descent altitude is reached. Once the vehicle 10 reaches the terminal descent altitude, a propulsive landing phase begins during which the pressure-fed engine of the vehicle 10 is operated to controllably land the vehicle 10 at a precise location where it can be retrieved and prepped for reuse.

In the illustrated embodiments, the vehicle 10 further includes a flight controller that is configured to transition the vehicle 10 between different operating modes during the different phases of a flight trajectory. The functionality of the flight controller can be implemented using analog and/or digital hardware (e.g., counters, switches, logic devices, memory devices, programmable processors, non-transitory computer-readable storage mediums), software, firmware, or a combination thereof. The flight controller can communicate with the respective flow controllers along the various conduits 50, 56, 76 via wired or wireless connections, and can perform one or more of the functions described herein by executing software, which can be stored, for example, in a memory device. Although the flight controller is described as a discrete component, in some embodiments the flight controller, or one or more components thereof, can be combined into a single component with the flow controllers along the various conduits 50, 56, 76, and/or one or more other components of the vehicle 10.

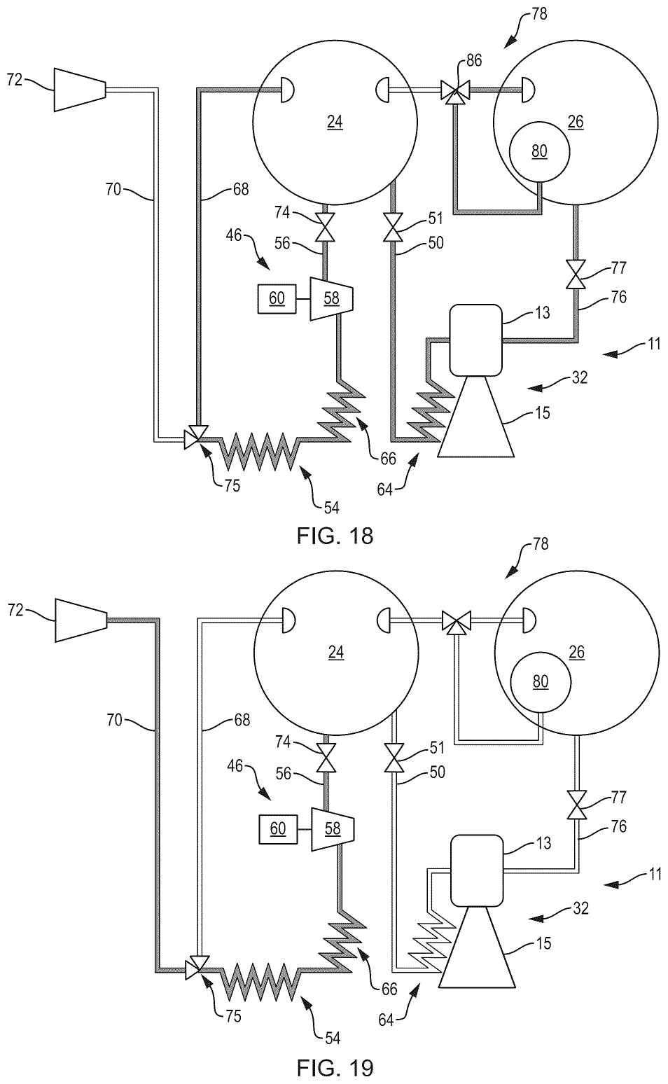

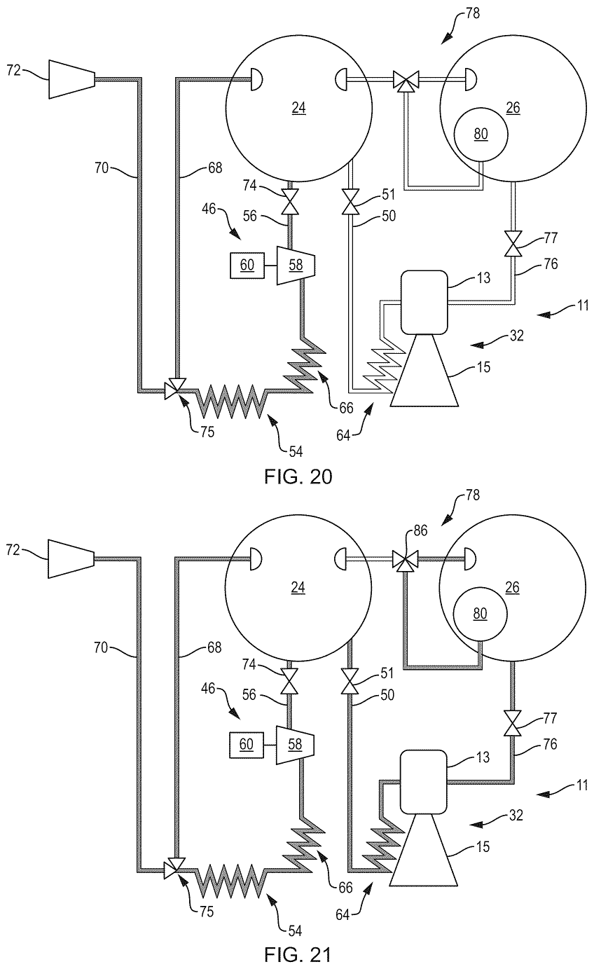

Referring to FIGS. 18-21, in the illustrated embodiments, the flight controller is configured to transition the vehicle 10 between at least a first operating mode (FIG. 18), a second operating mode (FIG. 19), a third operating mode (FIG. 20), and a fourth operating mode (FIG. 20). In FIGS. 18-21, the various conduits are shown. A conduit with dark grey fill indicates the presence of fluid flow in the respective conduit. A conduit without the dark grey fill indicates the absence of fluid flow in the respective conduit.

Referring to FIG. 18, the vehicle 10 is in the first operating mode after the vehicle 10 separates from the second stage rocket 16 and during the maneuver from a first orbital altitude to a second orbital altitude as shown in FIG. 17. In the first operating mode, the first and second flow controllers 74, 75 are configured such that fuel flows from the fuel tank 24 through the second conduit 56 and is then transported back to the fuel tank 24 via the first heated fluid conduit 68 for pressurization of the fuel tank 24. Also, the fuel flow controller 51 is configured such that fuel flows from the fuel tank 24 to the engine 11 via the first conduit 50, and the oxidizer flow controller 77 is configured such that oxidizer flows from the oxidizer tank 26 to the engine 11 via the oxidizer conduit 76. Also, the helium flow controller 86 is configured such that helium coolant flows from the helium vessel 80 to at least the oxidizer tank 26 via the one or more helium conduits.

Referring to FIG. 19, the vehicle 10 is in the second operating mode during a long duration dwell operation as shown in FIG. 17. In the second operating mode, the first and second flow controllers 74, 75 are configured such that fuel flows from the fuel tank 24 through the second conduit 56 and is then transported to the control thruster 72 via the second heat fluid conduit 70. Also, the fuel flow controller 51 is configured such that fuel does not flow from the fuel tank 24 to the engine 11 via the first conduit 50, and the oxidizer flow controller 77 is configured such that oxidizer does not flow from the oxidizer tank 26 to the engine 11 via the oxidizer conduit 76.

Referring to FIG. 20, the vehicle 10 is in the third operating mode during the atmospheric reentry phase of the flight trajectory which the heat shield and the base of the vehicle 10 defines the windward side of the vehicle 10 as shown in FIG. 17. In the third operating mode, the first and second flow controllers 74, 75 are configured such that fuel flows from the fuel tank 24 through the second conduit 56 and is then transported to both the fuel tank 24 (via the first heated fluid conduit 68) and the control thruster 72 (via the second heat fluid conduit 70). Also, the fuel flow controller 51 is configured such that fuel does not flow from the fuel tank 24 to the engine 11 via the first conduit 50, and the oxidizer flow controller 77 is configured such that oxidizer does not flow from the oxidizer tank 26 to the engine 11 via the oxidizer conduit 76.

Referring to FIG. 21, the vehicle is in the fourth operating mode after reaching the terminal descent altitude and beginning the propulsive landing phase of the flight trajectory as shown in FIG. 17. In the fourth operating mode, the first and second flow controllers 74, 75 are configured such that fuel flows from the fuel tank 24 through the second conduit 56 and is then transported to both the fuel tank 24 (via the first heated fluid conduit 68) and the control thruster 72 (via the second heat fluid conduit 70). Also, the fuel flow controller 51 is configured such that fuel flows from the fuel tank 24 to the engine 11 via the first conduit 50, and the oxidizer flow controller 77 is configured such that oxidizer flows from the oxidizer tank 26 to the engine 11 via the oxidizer conduit 76. Also, the helium flow controller 86 is configured such that helium coolant flows from the helium vessel 80 to at least the oxidizer tank 26 via the one or more helium conduits.

A method for operating the vehicle 10 includes the steps of pressure feeding a cryogenic fuel to the propulsion engine 11 and pressure feeding a cryogenic oxidizer to the propulsion engine 11. The steps of pressure feeding the cryogenic fuel and pressure feeding the cryogenic oxidizer do not involve use of a pump. In some embodiments, the step of pressure feeding the cryogenic fuel to the propulsion engine 11 involves delivering the cryogenic fuel to the propulsion engine 11 via a first conduit 50, and the method further includes delivering a coolant to a heat shield heat exchanger 54 disposed relative to a heat shield wall 52 that defines an outer surface of the vehicle 10. In some embodiments, the coolant and the cryogenic fuel are a same material. In some embodiments, the step of delivering the coolant to the heat shield heat exchanger 54 involves delivering the coolant to the heat shield heat exchanger 54 via a second conduit 56 that is not in fluid communication with the first conduit 50. In some embodiments, the cryogenic fuel is delivered to the propulsion engine 11 via the first conduit 50 at a first mass flow rate \dot{m}₁, the coolant is delivered to the heat shield heat exchanger 54 via the second conduit 56 at a second mass flow rate \dot{m}₂, and the second mass flow rate \dot{m}₂, is substantially less than the first mass flow rate \dot{m}₁, as described above. In some embodiments, the step of delivering the coolant to the heat shield heat exchanger 54 involves use of a pump 46 (e.g., an electric pump) that is in fluid communication with the second conduit. In such embodiments, the pump 46 is not in fluid communication with the first conduit 50.

While several embodiments have been disclosed, it will be apparent to those having ordinary skill in the art that aspects of the present invention include many more embodiments. Accordingly, aspects of the present invention are not to be restricted except in light of the attached claims and their equivalents. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

1-31. (canceled)

32. A vehicle, comprising:
a pressure-fed propulsion engine;
a first conduit configured to provide a first propellant to the pressure-fed propulsion engine;
a heat shield wall defining an outer surface of the vehicle;
a heat shield heat exchanger disposed relative to the heat shield wall;
a second conduit configured to provide a second propellant to the heat shield heat exchanger;
a pump located along the second conduit;
wherein the first conduit is configured to provide the first propellant to the pressure-fed propulsion engine at a first mass flow rate \dot{m}₁;
wherein the second conduit and the pump are configured to provide the second propellant to the heat shield heat exchanger at a second mass flow rate; and
wherein the second mass flow rate \dot{m}₂ is substantially less than the first mass flow rate \dot{m}₁.

33. The vehicle of claim 32, wherein respective magnitudes of the first mass flow rate rift and the second mass flow rate \dot{m}₂ are such that
$$\frac{{\dot{m}}_{2}}{{\dot{m}}_{1} + {\dot{m}}_{2}} \leq 0.01 0 .$$

34. The vehicle of claim 32, wherein respective magnitudes of the first mass flow rate rift and the second mass flow rate \dot{m}₂ are such that
$$\frac{{\dot{m}}_{2}}{{\dot{m}}_{1} + {\dot{m}}_{2}} \leq 0.02 0 .$$

35. The vehicle of claim 32, wherein respective magnitudes of the first mass flow rate rift and the second mass flow rate \dot{m}₂ are such that
$$\frac{{\dot{m}}_{2}}{{\dot{m}}_{1} + {\dot{m}}_{2}} \leq 0.03 0 .$$

36. The vehicle of claim 32, wherein respective magnitudes of the first mass flow rate \dot{m}₁ and the second mass flow rate \dot{m}₂ are such that
$$\frac{{\dot{m}}_{2}}{{\dot{m}}_{1} + {\dot{m}}_{2}} \leq 0.04 0 .$$

37. The vehicle of claim 32, wherein respective magnitudes of the first mass flow rate \dot{m}₁ and the second mass flow rate \dot{m}₂ are such that
$$\frac{{\dot{m}}_{2}}{{\dot{m}}_{1} + {\dot{m}}_{2}} \leq 0.05 0 .$$

38. The vehicle of claim 32, further comprising:
a fuel tank configured to store a fuel in fluid form;
wherein the first propellant is a first portion of the fuel stored in the fuel tank; and
wherein the second propellant is a second portion of the fuel stored in the fuel tank.

39. The vehicle of claim 38, wherein the fuel stored in the fuel tank is a cryogenic fuel;
wherein the vehicle further includes an oxidizer tank configured to store a cryogenic oxidizer in fluid form and an oxidizer conduit configured to provide at least a portion of the cryogenic oxidizer to the pressure-fed propulsion engine.

40. The vehicle of claim 39, wherein the cryogenic fuel is liquid hydrogen and the cryogenic oxidizer is liquid oxygen.

41. The vehicle of claim 32, further comprising:
a fuel tank configured to store a fuel in fluid form;
a coolant tank configured to store a coolant in fluid form;
wherein the first propellant is at least a first portion of the fuel stored in the fuel tank; and
wherein the second propellant is at least a first portion of the coolant stored in the coolant tank.

42. The vehicle of claim 41, wherein the fuel tank includes a fuel cavity in which the fuel is stored;
wherein the coolant tank includes a coolant cavity in which the coolant is stored; and
wherein the fuel tank and the coolant tank are configured such that the fuel stored in the fuel cavity is physically separate from the coolant stored in the coolant cavity.

43. The vehicle of claim 42, wherein the coolant tank is positioned within the fuel cavity of the fuel tank.

44. The vehicle of claim 42, wherein the coolant tank is positioned outside the fuel cavity of the fuel tank.

45. The vehicle of claim 32, further comprising:
an engine heat exchanger disposed relative to the pressure-fed propulsion engine;
wherein the engine heat exchanger is located along the first conduit.

46. The vehicle of claim 32, wherein the first conduit is not in fluid communication with the second conduit.

47. The vehicle of claim 32, wherein the vehicle excludes a pump in fluid communication with the first conduit.

48. The vehicle of claim 32, wherein the heat shield heat exchanger is configured to transfer energy from the heat shield wall to the second propellant received from the second conduit to generate a heated fluid flow.

49. The vehicle of claim 48, further comprising:
a fuel tank configured to store a fuel in fluid form;
a first heated fluid conduit between the second conduit and the fuel tank; and
a flow controller configured to selectively pass at least a first portion of the heated fluid flow from the second conduit to the first heated fluid conduit for transport to the fuel tank.

50. The vehicle of claim 49, further comprising:
an exogenous pressurization subsystem including:
a helium vessel configured to store helium coolant in gaseous form;
a helium conduit between the flow controller and an ullage space of the fuel tank;
a helium flow controller configured to receive helium coolant from the helium vessel;
wherein the helium flow controller is configured to selectively pass at least a first portion of the helium coolant received from the helium vessel to the helium conduit for transport to the fuel tank.

51. The vehicle of claim 50, further comprising:
an oxidizer tank configured to store a cryogenic oxidizer in fluid form and an oxidizer conduit configured to provide at least a portion of the cryogenic oxidizer to the pressure-fed propulsion engine;
wherein the helium vessel of the exogenous pressurization subsystem is positioned with the oxidizer tank.

52. The vehicle of claim 49, further comprising:
a control thruster;
a second heated fluid conduit between the second conduit and the control thruster; and
wherein the flow controller is configured to selectively pass at least a second portion of the heated fluid flow from the second conduit to the second heated fluid conduit for transport to the control thruster.

53. The vehicle of claim 32, wherein the vehicle is an upper stage rocket of a multi-stage rocket system.

54. The vehicle of claim 32, wherein the vehicle is a third stage rocket of a three-stage rocket system.

55. The vehicle of claim 32, wherein the pump is an electric pump.

56. A method for in-space and atmospheric reentry operation of a vehicle having a propulsion engine, comprising:
pressure feeding a cryogenic fuel to the propulsion engine;
pressure feeding a cryogenic oxidizer to the propulsion engine; and
delivering a coolant to a heat shield heat exchanger disposed relative to a heat shield wall that defines an outer surface of the vehicle;
wherein the steps of pressure feeding the cryogenic fuel and pressure feeding the cryogenic oxidizer do not involve use of a pump;
wherein the cryogenic fuel is delivered to the propulsion engine via a first conduit at a first mass flow rate \dot{m}₁,
wherein the coolant is delivered to the heat shield heat exchanger via a second conduit at a second mass flow rate \dot{m}₂;
wherein the second conduit is not in fluid communication with the first conduit; and
wherein the second mass flow rate \dot{m}₂, is substantially less than the first mass flow rate \dot{m}₁.

57-58. (canceled)

59. The method of claim 56, wherein the coolant and the cryogenic fuel are a same material.

60-61. (canceled)

62. The method of claim 56, wherein respective magnitudes of the first mass flow rate \dot{m}₁ and the second mass flow rate \dot{m}₂ are such that
$$\frac{{\dot{m}}_{2}}{{\dot{m}}_{1} + {\dot{m}}_{2}} \leq 0.05 0 .$$

63. The method of claim 56, wherein the step of delivering the coolant to the heat shield heat exchanger involves use of a pump that is in fluid communication with the second conduit.
